(19) United States
(12) Patent Application Publication
(10) Pub. No.: US 2017/0272532 A1
(43) Pub. Date: Sep. 21, 2017

(54) METHOD AND APPARATUS FOR CAPTURE CACHING

(71) Applicant: INTERDIGITAL PATENT HOLDINGS, INC., Wilmington, DE (US)

(72) Inventors: Kenneth F. Lynch, Wayne, PA (US); Jun Li, Cranbury, NJ (US); John Cartmell, North Massapequa, NY (US)

(73) Assignee: INTERDIGITAL PATENT HOLDINGS, INC., Wilmington, DE (US)

(21) Appl. No.: 15/505,479

(22) PCT Filed: Aug. 28, 2015
(86) PCT No.: PCT/US2015/047451

§ 371 Date: Feb. 21, 2017

Related U.S. Application Data
(60) Provisional application No. 62/043,057, filed on Aug. 28, 2014.

(51) Int. Cl. H04L 29/08; H04L 12/26; H04L 29/06; H04L 12/801

(52) U.S. Cl. CPC H04L 67/2847; H04L 47/14; H04L 47/35; H04L 43/028; H04L 69/22; H04L 69/324; H04L 67/306; H04W 88/16

(57) ABSTRACT

A method and apparatus for performing capture caching in a wireless network. A wireless transmit/receive unit (WTRU) or client device captures data from neighboring devices in the network and internally cache data that was traditionally cached in an edge node. The WTRU reassembles the captured data packets on a condition that the WTRU requests content associated with the captured data packets. If any segments are missing from the captured data packets, only those missing segments are retrieved from the server to repair the data. The reassembly of the data and the repair of missing segments is deferred until the data is needed by the WTRU.

### CROSS REFERENCE TO RELATION APPLICATION

This application is the U.S. National Stage, under 35 U.S.C. §371, of International Application No. PCT/US2015/047451 filed Aug. 28, 2015, which claims the benefit of U.S. Provisional Application No. 62/043,057 filed Aug. 28, 2014, the contents of which is hereby incorporated by reference herein.

### BACKGROUND

Serving content or data from a network proxy cache reduces traffic from the upstream and improves request response time. However, this only occurs when there is a cache hit and the probability of a cache hit is dependent on the amount of the cached content built by previous client requests. For wireless access points (APs) and small cell networks (SCNs), there is a problem in justifying the overhead of caching when there is a low cache hit ratio due to the small group of clients served.

### SUMMARY

A method and apparatus for performing capture caching in a wireless network. A wireless transmit/receive unit (WTRU) or client device captures data from neighboring devices in the network and internally cache data that was traditionally cached in an edge node. The WTRU reassembles the captured data packets on a condition that the WTRU requests content associated with the captured data packets. If any segments are missing from the captured data packets, only those missing segments are retrieved from the server to repair the data. The reassembly of the data and the repair of missing segments is deferred until the data is needed by the WTRU.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an example of transparent caching in a network;

FIG. 3 is an example of capture caching in a network;

FIG. 4 shows two client devices in a network requesting the same content without the use of capture caching;

FIG. 5 shows two client devices in a network requesting the same content with the use of capture caching;

FIG. 6 shows two client devices in a network requesting the same content with the use of capture caching where data may be repaired by requesting a missing piece or pieces from the network;

FIG. 7 shows an example architecture of a client device supporting capture caching;

FIG. 8 illustrates the data flow of an HTTP request through a capture caching stack in a client device;

FIG. 9 illustrates the data flow of an HTTP response through a capture caching stack in a client device;

FIG. 10 shows an example architecture of a gateway or router supporting capture caching;

FIG. 11 is a diagram of a network stack supporting capture caching that shows upstream traffic being monitored for HTTP requests and downstream traffic being checked to determine if it belongs to an HTTP session;

FIG. 12 shows the network topology for capture caching using dedicated cellular channels;

FIGS. 13A and 13B contain a diagram showing a message sequence chart (MSC) for capture caching using dedicated cellular networks;

FIG. 14 shows an example of a digital TV caching topology;

FIG. 15 shows a method for providing content caching in a digital TV caching topology;

FIG. 16 shows an example of a pre-fetch caching topology;

FIG. 17 shows a method for providing content in a pre-fetch caching topology;

FIG. 18 shows an example of a caching to offload a wired backhaul topology; and

FIG. 19 shows a method for providing content in a caching to offload a wired backhaul topology.

### DETAILED DESCRIPTION

Packet capture is a computer networking term for intercepting a data packet that is crossing or moving over a specific computer network and recording network traffic. Once a packet is captured, it is stored temporarily so that it may be analyzed. The packet may be inspected to help diagnose and solve network problems. Packet capturing is passive and it does not transmit or alter network traffic. Another term for packet capturing is packet sniffing.

A shared media network is a network where all bandwidth is shared with all stations at any given time. In a shared media networks, all stations may receive, or sniff, traffic from other stations. All wireless media is potentially shared media when accessed by multiple stations.

However, data transmitted over a shared media network may be encrypted with a non-shared key. For example, a cellular network (3G/LTE) uses per user equipment (UE) encryption key to protect data to one user from access by another user. A Wi-Fi network is an example of a shared media network where a shared key may be used by all stations under a Wi-Fi access point.

Byte serving refers to the process of sending only a portion of an HTTP/1.1 message from a server to a client. Byte serving begins when an HTTP server advertises its willingness to serve partial requests using the Accept-Ranges response header. A client then requests a specific part of a file from the server using the Range request header. If the range is valid, the server sends it to the client with a 206 Partial Content status code and a Content-Range header listing the range sent. If the range is invalid, the server responds with a 416 Requested Range Not Satisfiable status code. Clients which request byte-serving might do so in cases where a large file is only partially delivered and a limited portion of the file is needed in a particular range. Byte Serving is therefore a method of bandwidth optimization.

Embodiments described herein describe a method of caching data in a shared media network using packet capturing that improves over the current method by placing data one-hop closer without adding any network traffic. The caching of data one-hop closer to the source provides greater reduction in traffic for the network and faster response times for a client. By capturing data from neighboring devices in the network, clients may internally cache data that was traditionally cached in an edge node.

Embodiments described herein allow for content or data to be reassembled in the client. If any segments of the content or data are missing, only those missing segments need to be retrieved from the server to repair the data. The reassembly of the data and repair of any missing segments may be deferred until the data is actually needed by the client.

Embodiments described herein also describe methods where a network node acts alone and an edge node assists the network node in identifying and marking data. A hybrid protocol with aspects of unicast and multicast may be used to provide a reliable delivery between two endpoints and an unreliable delivery to other endpoints. This method may be used in any shared media network where multi-casting is possible and may require minor changes to the network stack. Example designs for Wi-Fi and cellular networks are disclosed herein, including a variation using dedicated channels. Several embodiments using digital TV broadcast for wired backhaul are also provided.

Again, serving resources from a network proxy cache reduces traffic from the upstream and improves request response time. The use of capture caching moves the caching functionality out of an edge node and into clients. The use of capture caching also allows edge nodes to expand their cache pool to include all client requests from neighboring edge nodes.

Example use cases of capture caching are described below.

In a first use case, small cell networks with cellular backhaul could benefit from capture caching. The cellular backhaul traffic may be reduced by placing cache content in the small cells that was previously held in the upstream node.

In a second use case, capture caching may be used with delta-transfer. Delta-transfer is a method that optimizes network throughput when using redundant content such as HTML by sending differences from the original content. This makes using capture caching to keep the local cache as fresh as possible very beneficial. For instance, if a device has a one hour old version of a news page and then uses capture caching to get a more recent version, when the device requests that data five minutes later the delta transfer will be much smaller with five minute old content than one hour old content.

In a third use case, capture caching may be used to minimize wireless congestion at a sporting event where users tend to visit the same web sites. For example, SportsStats.Com is a web site that allows users to looks up all sorts of stats on the players. Joe and John are fans in the audience of a stadium. Joe looks up the stats for his favorite player, Smith. At the same time John has an active device that is aware of his preference for SportsStat.com. John's device detects the response with Smith's stats and caches it locally in his phone. When John uses SportsStats to look up Smith's stats later on, the request is served from his local cache eliminating any over-the-air network traffic that would have normally occurred.

In a fourth use case, capture caching may be used with video services. For example, if two devices are watching same video, the one device lagging behind may start pre-caching. This may be done without the server's knowledge. Technology also exists that allows video or audio streams to be multicast to various devices, but these technologies typically require the server to be aware of each subscribing node. With capture caching, the server does not need to be aware of the subscribers. The edge node and devices may work together to form a subscriber group for the desired streaming media.

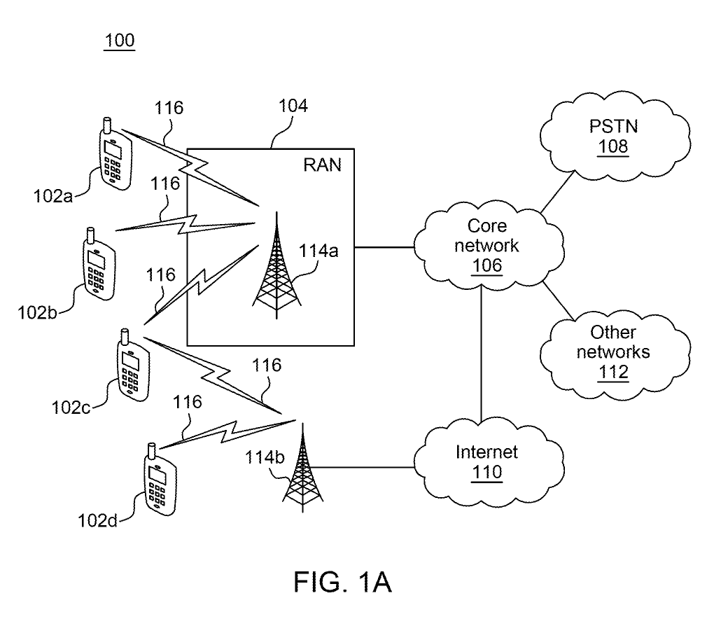

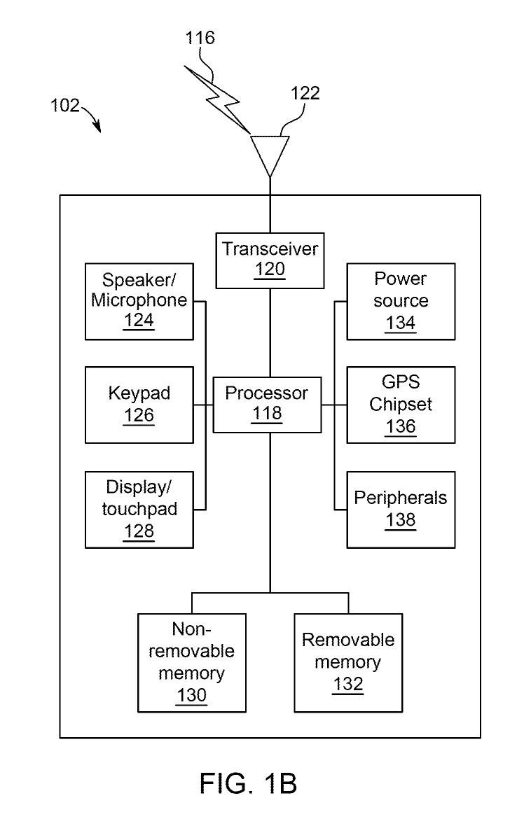

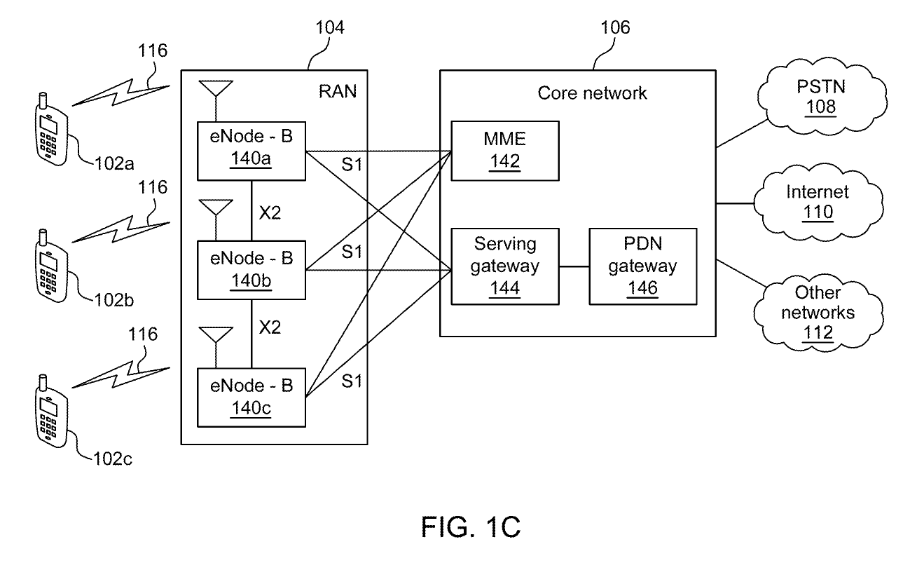

Referring now to FIG. 1A, a diagram of an example communications system 100 in which one or more disclosed embodiments may be implemented is shown. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include client devices, user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like. FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Capture caching may increase the number of caches serving the same content with a minimal increase to the cache prepositioning cost. The logic of traditional transparent caching is that content will be requested multiple times from the same cache.

In a small cell network (SCN), this logic fails because the number of users from each eNodeB is so small that there is little chance for a second request for the same content. Most of content is requested only once and has little caching value to users under the same eNodeB. The capture caching may cache content to the neighboring eNodeBs other than where the request for content is made. In the neighboring eNodeBs, if the content has not yet been requested, the chance of the content being requested may be much higher. This suggests that capture caching may lead to the increased efficiency that transparent caching lacks in SCNs. For those eNodeBs with similar user profiles, capture caching is more beneficial. Alternatively, an eNodeB may check if content fits its profile before a capture is performed.

Transparent caching relies on content requests made by the clients under the same cache node. Capture caching has a wider range and relies on content requests made by the clients under neighboring cache nodes. However, the content request space in a SCN is still too small to determine the best content to be cached.

Content distribution networks (CDNs) may be used to push content proactively to edge caches based on statistics from a global content request space. If a CDN is pushing content to eNodeBs in an SCN, capture caching may be used to reduce the overall distribution cost. For example, suppose content-A is on the pre-fetching list of both eNB-1 and eNB-2, but with different ranks. On eNB-1, content-A is the first to be pre-fetched while on eNB-2, it ranks No. 10. Then at the time eNB-1 is requesting content-A, eNB-2 can capture it. When eNB-2 is requesting content-A, it already has the majority the content, and only a repair of missing blocks is required. Thus, the shared backhaul of eNB-1 and eNB-2 can be significantly saved. With capture caching, in the unit time during off-peak hours, more content may be prepositioned into the caches in the same SCN.

Although cellular networks normally do not support shared keys for channel protection, there are two use cases in which a cellular operator may consider using a shared key to make a shared media downstream wireless channel for client stations.

In a first use case, a macro cell channel resource may be used as small cell eNodeBs' backhaul channels. The backhaul cost is very high and using a shared key for all eNodeBs using the same macro cell base station may enable capture caching.

In a second use case, a cellular operator may use a shared key and make a downstream wireless channel shared media for client stations receiving data through the channel in a big stadium during a major sports event. In this setting, the probability of mobile users interested in the same content is very high. In order to reduce the congestion caused by duplicated requests from different users, the cellular operator may use a shared channel key for all subscribers to make the wireless channel become true shared media. Capture caching may then be used to reduce the cost of content delivery.

While multicasting is an existing layer 2 mechanism that could be used, multicasting does not provide reliable, or acknowledged, data transfer at that layer. Retransmissions of damaged data could be left for the higher levels, but this would adversely affect performance compared to unicast transfers.

Reliable multicast mechanisms would not work because the desire is to not add any networking overhead until it is known that a cache hit is possible. A variation, or combination, of multicast and unicast is recommended where there is still a reliable or acknowledged delivery between two end points, yet other nodes are addressed and allowed to passively sniff the data in an unreliable or unacknowledged way. As a result, the upper layers would remain unchanged and addressing at the network layer would still be unicast.

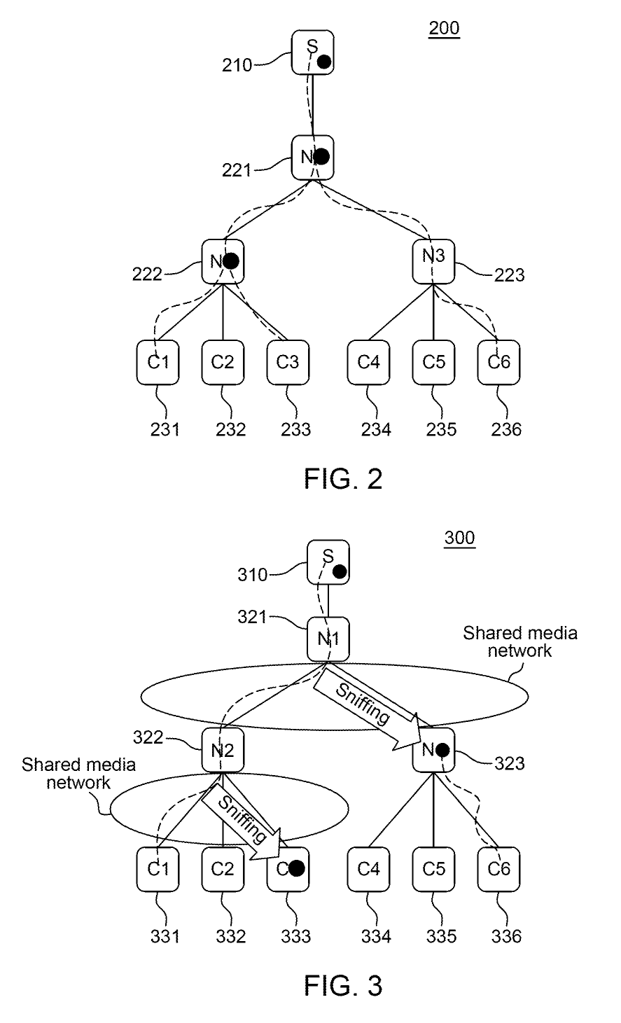

FIG. 2 shows an example of transparent caching in a network. In FIG. 2, the network 200 may include a server (S) 210, network nodes (N1, N2, N3) 221, 222, 223, and client devices (C1, C2, C3, C4, C5, C6) 231, 232, 233, 234, 235, 236. Network node (N1) 221 communicates with the server (S) 210 and network nodes (N2, N3) 222, 223 communicate with network node (N1) 221. Network node (N2) 222 communicates with client devices (C1, C2, C3) 231, 232, 233 and network node (N3) 223 communicates with client devices (C4, C5, C6) 234, 235, 236.

Referring to FIG. 2, the caching process is performed in network node (N1) 221 and network node (N2) 222. FIG. 2 shows client device (C1) 231, client device (C3) 233, and client device (C6) 236 requesting the same content or data from the server (S) 210 in that respective order. The content is cached in network node (N1) 221 and network node (N2) 222 when client device (C1) 231 retrieves the content from the server. Client device (C3) 233 retrieves the content from a cache in network node (N2) 222, taking only one hop to get the data, and saving two hops. Client device (C6) 236 takes two hops to retrieve the content from the cache in node (N1) 221, saving one hop.

Caching the content in network node (N2) 222 provides the shortest path to the data for the clients, and gives the greatest reduction in backhaul traffic. However, caching in network node (N2) 222 may only be done for three client devices (C1, C2, C3) 231, 232, 233. Caching in network node (N1) 221 may be done for all six client devices (C1, C2, C3, C4, C5, C6) 231, 232, 233, 234, 235, 236, but the path to the client devices is not as short and the backhaul reduction is not as great.

When cached content is built by client requests (transparent caching), requests from a small group of users in a small cell network cannot build a high hit ratio cache statistically. In such circumstances, a larger user pool is required in order to generate content requests to build cache without increasing the overall backhaul traffic load.

If the network between network nodes (N1, N2, N3) 221, 222, 223 shown in FIG. 2 is a shared media network, such as Wi-Fi or cellular, each network node may sniff the traffic of its neighboring nodes and cache content of interest one hop closer to the client devices without incurring any additional network overhead.

FIG. 3 shows an example of capture caching in a network. Capturing caching or sniffing may be used to improve the effectiveness of caching in a network. This method is also referred to as capture caching.

In FIG. 3, the network 300 may include a server (S) 310, network nodes (N1, N2, N3) 321, 322, 323, and client devices (C1, C2, C3, C4, C5, C6) 331, 332, 333, 334, 335, 336. Network node (N1) 321 communicates with the server (S) 310 and network nodes (N2, N3) 322, 323 communicate with network node 321 (N1). Network node (N2) 322 communicates with client devices (C1, C2, C3) 331, 332, 333 and network node (N3) 323 communicates with client devices (C4, C5, C6) 334, 335, 336.

Referring to FIG. 3, network node (N3) 323 may sniff content or data as it passes from network node (N1) 321 to network node (N2) 322 and cache it. As a result, when client device (C6) 336 requests the content it may be served from the cache in network node (N3) 323. If the network between network node (N2) 322 and client devices (C1, C2 C3) 331, 332, 333 is a shared media network, client device (C3) 333 may sniff the content when it is received by client device (C1) 331. When client device (C3) 333 requests the content later the content may be served up from its own internal cache, with the minimal response time and no network utilization.

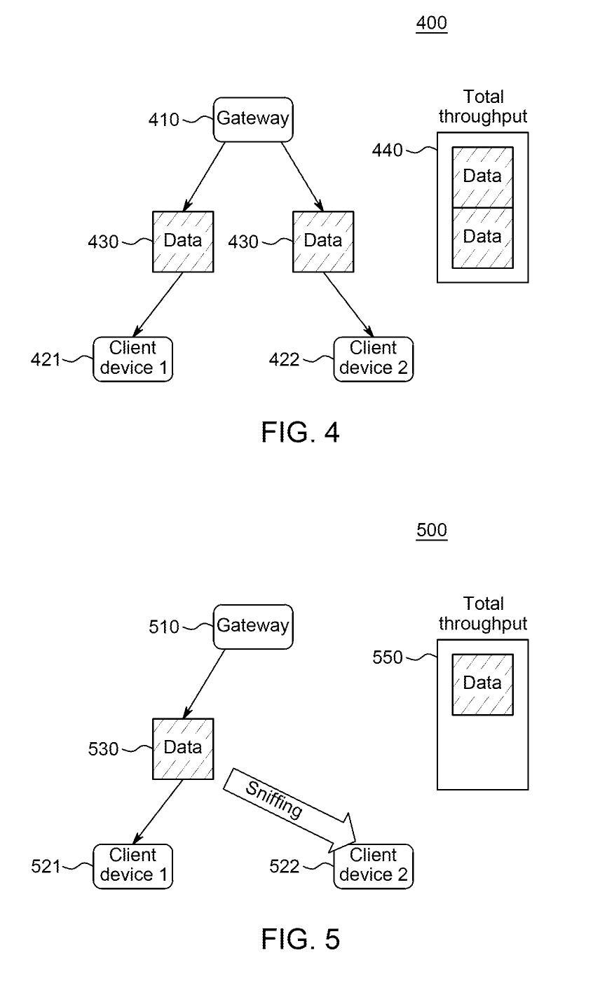

FIG. 4 shows two client devices in a network requesting the same content without the use of capture caching. In FIG. 4, the network 400 may include a gateway 410 and client devices (WTRUs) 421, 422. A copy of data 430 may be sent separately to both client devices 421, 422, so the utilized bandwidth is two times the size of the data. As a result, the total required throughput 440 is two times the size of the data.

FIG. 5 shows two client devices in a network requesting the same content with the use of capture caching. In FIG. 5, the network 500 may include a gateway 510 and client devices (WTRUs) 521, 522. Referring to FIG. 5, client device 522 may sniff or capture data 530 when the data is loaded by client device 521 and does not need to retrieve the data 530 over the network later when it is needed. As a result, the total required throughput 540 is significantly reduced as compared to the implementation shown in FIG. 4.

The client device 522 may have to reassemble the data 531 using the same logic found in client device 521. For example, the data 531 includes packets that may arrive out of order, such as in transmission control protocol (TCP), and the client device 522 may have to reassemble the data. However, if a packet in the data 530 is not received properly at the client device 522 (e.g., due to a bit error), the client device 522 cannot request a retransmission because the client device 522 is passively capturing the packets. The client device 522 may attempt to reassemble the data with “holes”, assuming essential header information of the data 530 was received correctly. Alternatively, the client device 522 may drop all of the data that was not received properly or the client device 522 may choose to receive the damaged data and attempt to repair it.

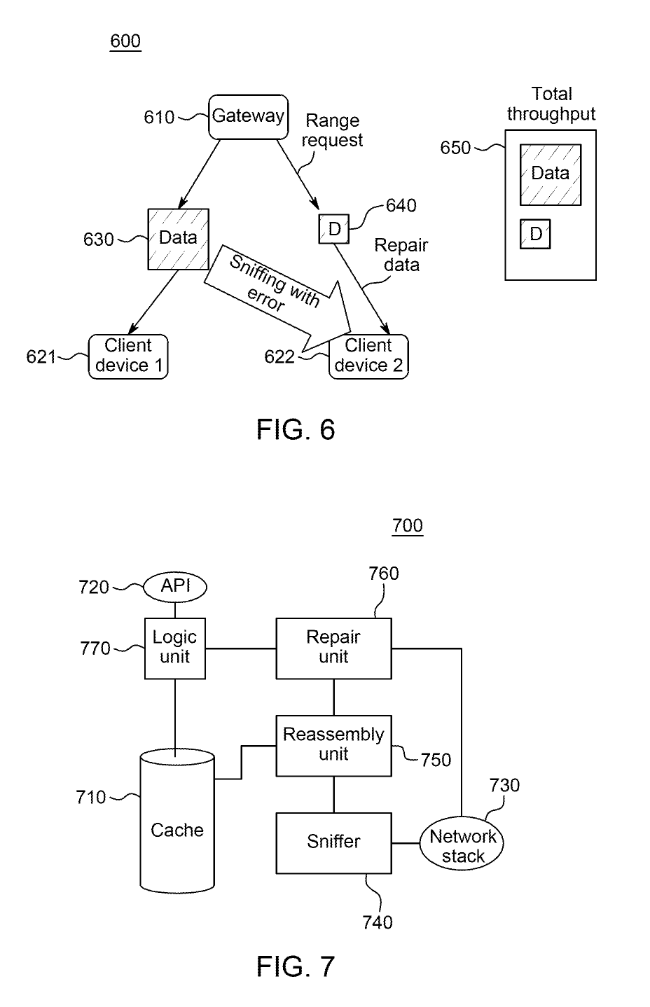

FIG. 6 shows two client devices in a network requesting the same content or data with the use of capture caching where data may be repaired by requesting a missing piece or pieces from the network. In FIG. 6, the network 600 may include a gateway 610 and client devices (WTRUs) 621, 622. Referring to FIG. 6, client device 622 may sniff or capture data 630 when the data is retrieved by client device 621 so that client device 622 does not need to retrieve the data 630 over the network later when it is needed.

As described above, client device 622 may have to reassemble the data 630 using the same logic in client device 621. In FIG. 6, client device 622 sniffs or captures the data 630 while client device 621 was receiving it but there were errors which left some holes in the reconstructed data. Client device 622 may attempt to repair the data 630. The data 630 may be repaired by the client device 622 requesting just the missing piece or pieces 640 from the gateway 610 when the data is needed as shown in FIG. 6. The repair process may be deferred until the data is actually needed.

When client device 622 requests the data 630, only the missing portion of the sniffed data 640 needs to be retrieved. Assuming the repair data is 10% of the original, the throughput has been reduced to 55% of the throughput found in FIG. 4 and the processing complexity is only slightly increased.

The content that is cached in the paragraphs above may be an HTTP object. The data format for an HTTP object may include a HTTP header and a HTTP body. The HTTP body may include a size field, a BytesMissingCount field, and section arrays (e.g., start offset, end offset, and data). The HTTP protocol also specifies a range request which allows a portion of content to be retrieved.

When caching HTTP objects, HTTP requests are checked for a URL that a device (e.g., node or client device) in a network is interested in caching, and if found, then the response will be captured. After the client device in the network receives the response HTTP header, it may be examined to see if the client device should continue to capture the HTTP data. For example, the client device would stop storing the packets of the specific flow if the header indicates that the data is the same as the data that the device already has cached.

The device in network supporting capture caching may use similar logic to decide what server responses should be cached as would be used in the network node upstream. For example, if an edge node decides to cache content or data because it is likely that it will be requested by multiple client devices, then sniffing clients should also cache the content or data. However, since the downstream devices may not have as much storage capacity devices, downstream devices may optimize this logic to take into account the needs of each downstream device. For example, a downstream device may cache content or data because it is likely to be requested by that device. One example algorithm is to cache content from domains that the client has requested in the past, or to freshen already cached content with newer versions.

In the embodiments described above, capture caching is performed in a client device and there are no changes to the upstream network nodes. In another embodiment, an upstream node may assist in parsing the data and identifying which content should be cached. An edge node may mark the data in a manner so that the client devices may filter, at a low level, the marked data that the client device has a high likelihood of utilizing at some time in the future. This alternative may minimize the processing requirements of capture caching on a client device.

In order to assist an upstream node in parsing the data and identifying which content should be cached, a special method of marking or tagging packets is needed to allow other devices to quickly filter only the packets they should capture. The method of marking or tagging packets should not affect unicast flows.

For example, a device or edge node may mark the packets of an HTML request containing a resource that should be captured and cached by specific devices besides the destination end-point device. The destination end-point device then normally receives the HTML response, and the other targeted devices would capture the packets and know whether to cache the packets based on a specific marking within the packet header. The marking may be able to address various combinations of all of the network devices. The normal unicast address and filtering process remains unchanged.

Packets may be marked using a special addressing scheme or by using other spare or unused bits in the headers, preferably at a fixed offset. In one embodiment, packets are marked using address 4 in the 802.11 header if a wireless distribution system (WDS) is not in use. In another embodiment, packets are marked using IP or TCP header options.

The use of data marking may allow a device or edge node to target specific devices. An initial process of enumerating all nodes is assumed, for example, dynamic IP address allocation.

In a first embodiment, a device or edge node may target specific devices using a bit map where a bit is set to address each client device. The use of a bit map enables the addressing of any combination of client devices provides fast client side matching. However, only a limited number of client devices may be supported (e.g., with 46 bits available only 46 client devices can be addressed).

In a second embodiment, a device or edge node may target specific devices using a combination enumeration. If there are more client devices in a network than a bit map is able to handle, a method using N out of M permutations may be used. This method allows at most N devices to be addressed at once. If more than N devices need to be addressed, then a broadcast is needed. Assuming 46 bits, the total number of possible combinations may be less than the maximum address space of 2̂46, and 10 out of 100 works, or 7 out of 256. This embodiment requires an easy method for a client device to identify the multicast address to which it belongs.

In a third embodiment, a device or edge node may target specific devices using an encoded digit string. For example, using a digit of 9 bits which indicates a receiver, 1-511, or 0 for none. Assuming 46 bits, up to 5 client devices of 511 total may be indicated. This embodiment allows clients to easily identify a match (e.g., 5 bit masks in this case) but it is not as efficient using address space as combinations.

The use of data marking may also allow for the creation of groups, similar to multicast groups, based on content type. There are several different methods for enumerating the groups.

In a first embodiment, packets may be marked using a hash algorithm of some portion of a data identifier, for example the domain name (FQDN). Then, a client device interested in content from a specific domain name would filter packets based on the specific domain names of interest. For example, a client may select domain names that were accessed frequently in the last day. As the multiple domains may map to the same hash, the actual domain may be compared after the data is received.

In a second embodiment, a device or edge node may broadcast a directory of classification groups thereby allowing client devices to subscribe to groups of interest.

In a third embodiment, predefined static classifications may be used (e.g., sports, news, etc.) in the creation of groups based on content type.

In a fourth embodiment, a cloud-based service may be used to store and calculate user preferences for content types or web sites. This calculation may be based on information in the cloud such as a user's social network profile or internet search engine history, as well as those of the user's friends and family. The cloud-based service maps the device to a user using a device ID, such the MAC address, detected by the access point. A user ID may be read from the device in an application, the AP may read the user ID, or a user may manually enter the user ID.

The embodiments described above may also support the use of control messages to improve the efficiency of capture caching in the network.

In a first embodiment, control messages may be used to broadcast a directory of multicast groups by content type to client devices thereby enabling the client devices to subscribe to the groups.

In a second embodiment, a client device may use messages to signal edge nodes and provide feedback to the edge node regarding the data of interest to the client device.

In the backhaul, data may be secured at the data link layer using a common key/encoding for all participating nodes. For end nodes, data may be secured within a select group by using multicasting with a shared key only known by that group. Data may also be encrypted at the application layer so that only the selected applications may view the data after it is received. If data is encrypted uniquely based on each client-server session, such as with HTTPS, then this data may not be cached by other nodes. For data marking purposes, upstream nodes may need visibility into the data to classify or mark the data.

The paragraphs below describe an example embodiment for performing capture caching in a network using HTTP. The additional features of edge node data marking and error repair may also be supported in the network.

FIG. 7 shows an example architecture of a client device supporting capture caching. The client device (WTRU) 700 includes a cache 710, an API 720, a network stack 730, a sniffer 740, a reassembly unit 750, a repair unit 760, and a logic unit 770.

The sniffer 740 is coupled to the network stack 730 and captures data packets (e.g., TCP packets). The data packets may be directed to other devices in a wireless network and not directed to the client device 700. The data packets are may be captured because the data packets are of interest to the client device 700. The data packets of interest are not destined to the client device 700. The sniffer 740 may capture the packets of interest by filtering based on layer 2 marks inserted by the gateway. The sniffer 740 may be configured with a list of markers to filter by. The functions performed by the sniffer 740 may be carried out in one or more processors or by software code run on one or more processors. The one or more processors performing the functions of the sniffer 740 may be coupled to a transceiver to capture the packets of interest.

The reassembly unit 750 reassembles the captured data packets on a condition that the client device requests content associated with the captured data packets. The reassembly unit 750 puts together response data from packets taking into account retransmissions. If the header was received correctly, the reassembly unit 750 may store the rest of the packets in a database and defer processing until a cache hit. Data will be dropped if a number of errors associated with the data exceeds a threshold or the header is damaged. The URL is placed into the response header by the edge node so the client does not need to track requests.

The cache 710 holds HTTP requests, headers and body. The body may be stored unassembled (e.g., as TCP packets) before it is needed due to a cache hit.

The repair unit 760 may use byte serving (e.g., HTTP range requests) to gather missing sections of damaged data. This may not be necessary if the data was received without error.

The logic unit 770 implements API 720 which checks cache for valid content or data objects. If a valid content or data object is found, the logic unit 770 orchestrates reassembly and repair of data, if necessary. The logic unit 770 also decides what content or data objects should be removed from the cache 710 to make room for new content or data objects, or if new content or data objects should be ignored because the cache is full. The API 720 also allows a user to configure which domains (FQDNs) to capture in the client device, which are in turn configured in the sniffer 740.

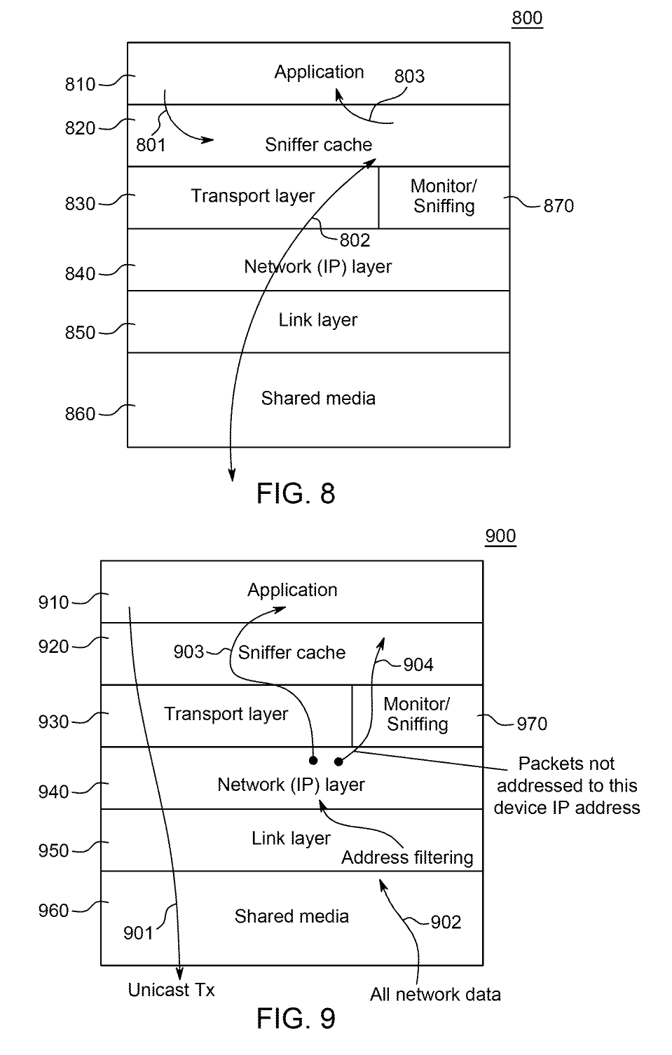

FIG. 8 illustrates the data flow of an HTTP request through a capture caching stack in a client device. The capture caching stack 800 includes an application layer 810, a sniffer cache 820, a transport layer 830, a network (IP) layer 840, a link layer 850, a shared media layer 860, and a monitoring/sniffing layer 870.

In step 801, the application 810 (browser) makes an HTTP request that results in a sniffer cache hit. For example, the URL matches and the HTTP header indicated that this data may be cached.

In step 802, the data object body is assembled and it is determined to be missing a section. The sniffer cache 820 retrieves only damaged section from the server and repairs the data object. For example, an HTTP range request is used to read the missing segment.

In step 803, the sniffer cache 820 returns the whole data object to application 810.

FIG. 9 illustrates the data flow of an HTTP response through a capture caching stack in a client device. The capture caching stack 900 includes an application layer 910, a sniffer cache 920, a transport layer 930, a network (IP) layer 940, a link layer 950, a shared media layer 960, and a monitoring/sniffing layer 970.

In step 901, a client device (originating device) makes an HTTP request. A gateway receives a response from the server and decides it should be cached by other nodes. Within the gateway, the request URL is added to the response header, and the packets are marked to be captured by specific nodes.

In step 902, all the data is received by the client device and the client device is in a promiscuous mode. In one embodiment, the MAC address filter is modified to handle bit masking and promiscuous mode would not be necessary. The link layer filters out all packets except for: packets destined for this device in the traditional protocol (e.g., unicast, broadcast, and multicast); and specially marked packets to be capture cached. The specially marked packets to be capture cached should be treated in the same way as multicast or broadcast packets (i.e., no acknowledgements). The path then varies based on whether the client device is an originating node or a sniffing device.

In step 903, the client device is the originating node and the packet is sent to the transport layer 930 if the destination IP address matches the network device.

In step 904, the client device is a sniffing device and the packet is sent to the sniffer cache 920 if the destination IP address does not match the network device.

An edge node may perform processing to significantly offload the processing requirements in the clients since the clients may be resource constrained. This processing includes, tracking HTTP sessions by mapping requests to responses, and identifying which responses should be cached.

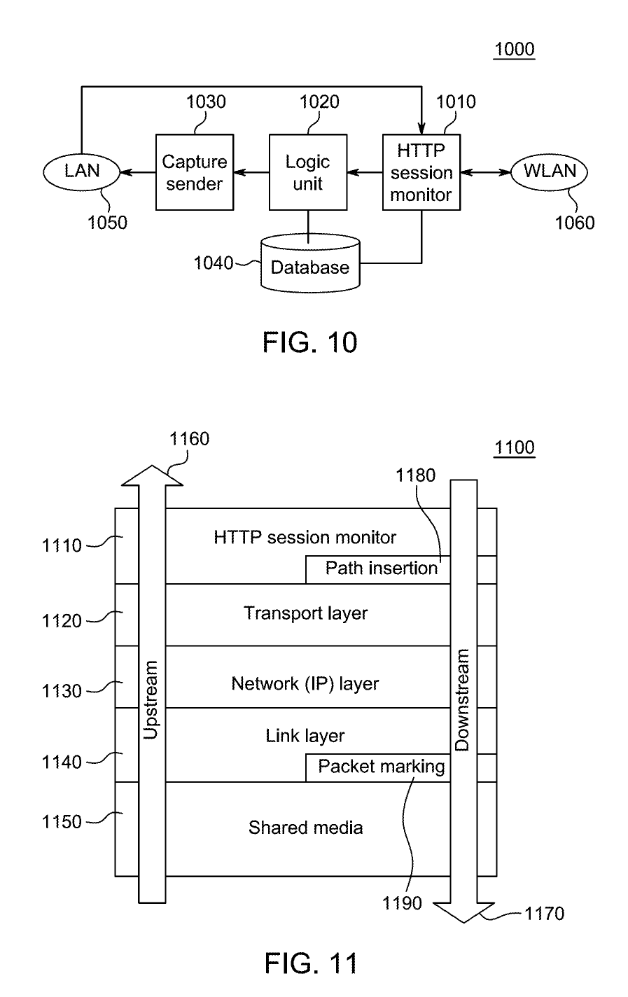

FIG. 10 shows an example architecture of a gateway or router supporting capture caching. The router 1000 includes a HTTP session monitor 1010, logic unit 1020, a capture sender 1030, database 1040, a LAN connection 1050, and a WAN connection 1060.

The functions performed by the HTTP session monitor 1010 are tracking HTTP sessions (e.g., HTTP transparent Proxy) and reading HTTP headers of requests and responses. The functions performed by the HTTP session monitor 1010 may be carried out in one or more processors or by software code run on one or more processors. The one or more processors performing the functions of the HTTP session monitor 1010 may be coupled to a transceiver that receives the packets in the HTTP sessions. The function performed by the logic unit 1020 is tracking request history per client. The functions performed by the logic unit 1020 may be carried out in one or more processors or by software code run on one or more processors. The functions performed by the capture sender 1030 includes: handling modifications necessary to cause clients to cache responses; inserting entity into extension header of response to indicate the URL to client so clients do not need to capture requests; and marking response packets so the packets can be easily cached by other clients using a hash code of the FQDN using address 4 of 802.11 frame if a WDS is not in use. The functions performed by the capture sender 1030 may be carried out in one or more processors or by software code run on one or more processors.

FIG. 11 is a diagram of a network stack supporting capture caching that shows upstream traffic being monitored for HTTP requests and downstream traffic being checked to determine if the traffic belongs to an HTTP session. The network stack 1100 includes an HTTP session monitor 1110, a transport layer 1120, a network (IP) layer 1130, a link layer 1140, and a shared media layer 1150. The HTTP session monitor 1110 may include a path insertion function 1180. The link layer 1140 may include a packet marking function 1190.

Referring now to FIG. 11, the upstream traffic 1160 is monitored for HTTP requests. When an HTTP request is found, the session is tracked. Meanwhile, downstream traffic 1170 is checked to determine if it belongs to an HTTP session. If so, the HTTP response header is read. If the HTTP response should be cached by client devices, then the URL path of the session is inserted into the HTTP response header by the path insertion function (this is a custom header field used to allow a client device to identify the data object in the response without having to track the requests). Response packets of cacheable request flows are marked, by the packet marking function, in a way to be captured by specific client devices and received by the destination endpoint. Many methods of marking may be used, including special addressing schemes. For example, in FIG. 11, a hash of the FQDN is being used for marking. The IP address is not changed so that the session endpoint may identify the data as belonging to it, and the rest of the network stack may function as usual.

The paragraphs below describe capture caching with cellular networks using multimedia broadcast multicast service (MBMS). MBMS is defined in the 3^{rd} Generation Partnership Project (3GPP) standards. MBMS utilizes a common channel to broadcast media to all users of a specific group of eNBs. Each eNB synchronizes the transmission of the media so that each WTRU may use soft combining techniques to receive the commonly transmitted material. A downside of the 3GPP defined MBMS is that each eNB receives a copy of the data. If the backhaul between the eNBs and core network is wired, then there is a large inefficiency of sending the common media to each eNB.

Therefore, in this embodiment, a wireless backhaul may be used between the eNBs and the mobile core network. In addition, the material broadcast by the core network towards the eNBs may be done over a common channel on this wireless backhaul. Therefore, the core network only needs to transmit the material once. When received by the eNBs, the eNBs may synchronize the transmission towards the WTRUs.

The embodiments described herein may be applied directly to this network configuration. If a WTRU is not able to completely receive the transmitted media, the WTRU may note which sections of the media it received properly and then request the corrupt or missing parts by use of a dedicated channel between it and the eNB. Likewise, if an eNB did not receive the entire media, the eNB may request the missing or corrupt portions to repair these parts.

Since both the backhaul between the core network and the eNBs and the air interface between the eNBs and the end-user devices both use common channels, there is no waste of resources in having each eNB and each WTRU receive the common media.

LTE MBMS (eMBMS) uses multicast-broadcast single frequency network (MBSFN) that targets TV and/or radio broadcasting service. MBSFN uses the same frequency band for all cells and broadcast the same content over the air. Therefore, using eMBMS for capture caching may be done for TV applications.

Currently, there is no commercial deployment of eMBMS because it requires dedicated cellular radio resource across the whole network regardless of user distribution. eMBMS uses a conservative coding scheme to ensure the edge of cell also has coverage. Since eMBMS uses the radio resource inefficiently, its economic benefit cannot be justified. The 3GPP specification group of radio access network (TSG-RAN) proposes a support of single cell point-to-multicast (SC-PTM) by Release 13 to support emergency communications. Besides use in critical communications, SC-PTM transmission may also be used for other commercial use cases, e.g. top videos/popular apps download, mobile advertising, traffic information for cars, etc.

The capture caching embodiments described herein may be used in the SC-PTM, where radio resource may be more dynamically allocated depending on the user distribution. For example, if a WTRU does not join a SC-PTM group, an eNB may not provide enough radio resource for the WTRU to get the content over the SC-PTM channel. However, the WTRU may still use capture caching to cache the majority of the content and later, if the WTRU wants to view the content, the WTRU may request the missing section of the content.

The paragraphs below describe capture caching in an information centric network (ICN). Information centric networking is a paradigm shift of data communication. Further, once mobile networks become information centric networks, the capture caching embodiments described herein may be applied.

In an ICN, the center of the communication process is content instead of WTRUs. Assuming future mobile network (5G and beyond) supports ICN, although a radio channel may be dedicated to content with consideration of WTRUs subscription to the content, capture caching may still be used to improve the efficiency of radio resource utilization for WTRUs that are not yet subscribers.

A content dedicated radio channel may be considered as a SC-PTM channel with further dynamic radio resource allocation techniques based on subscriber group. Instead of using a coding scheme and power to ensure the coverage of the whole cell, the content dedicated channel may optimize the radio resource allocation based on the type of content and the location of subscribers using proper coding, power and beamforming.

The capture caching embodiments described herein may be used in the ICN context. For example, an eNB assigns a content dedicated channel D (e.g., SC-PTM) for content S to a group of subscribers G. WTRU X, who is not yet a member of G, is a potential subscriber according to the user profile. A decryption key for the content dedicated channel D is available to non-subscribers, such as WTRU X, similar to a shared key in Wi-Fi. The shared key may also be distributed. Because channel D is accessible even if WTRU X is not a member of group of subscribers G, WTRU X may cache content S using capture caching.

If content is accessible only for subscribers, a content level DRM may be applied to group of subscribers G. If WTRU X becomes a subscriber to the content S, WTRU X will have access right as a member of group of subscribers G. Then, WTRU X may use the cached copy of S and request retransmission of corrupted sections if needed.

The paragraphs below describe capture caching in cellular networks using dedicated channels. Capture caching may be performed without using a shared channel, such as an eMBMS or SC-PTM channel.

An embodiment of capture caching with cellular networks using dedicated channels is now described. This embodiment entails the use of dedicated channels to perform capture caching, so data still has to be sent individually to each end-user device. The backhaul may use some type of wireless multicast arrangement, perhaps as described previously. The use of a wireless backhaul is preferred even though the paragraphs below do not address the backhaul.

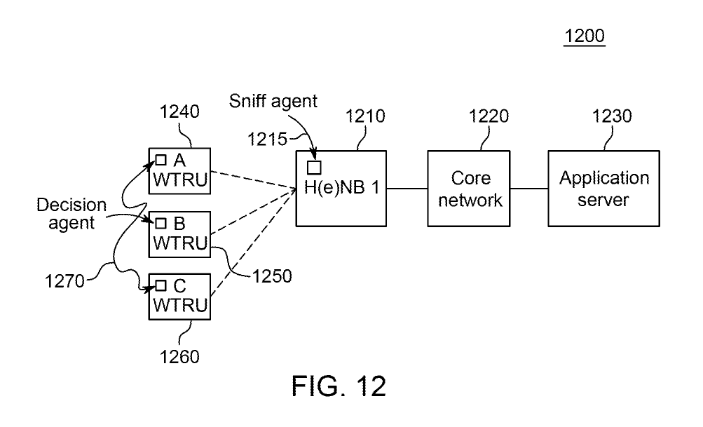

FIG. 12 shows the network topology for capture caching using dedicated cellular channels. The network 1200 includes an H(e)NB 1210, a core network 1220, an application server 1230, and WTRUs 1240, 1250, 1260.

As shown in FIG. 12, the H(e)NB 1210 includes a Sniff Agent 1215. The functions performed by the Sniff Agent 1215 may be carried out in one or more processors or by software code run on one or more processors. The Sniff Agent 1215 is configured to eavesdrop on all traffic to and from any WTRU connected via the H(e)NB 1210. The Sniff Agent is also configured to search for content requests in the data traffic from each WTRU 1240, 1250, 1260. When the Sniff Agent detects a content request, the Sniff Agent is configured to query all of the other WTRUs attached to the H(e)NB 1210 whether it would like a copy of the content. Each WTRU then responds and the H(e)NB 1210 is configured to remember which WTRUs replied “yes” to the query. When content begins flowing from the application server 1230 to the original target WTRU, the H(e)NB 1210 is configured to make a copy of the data and push it to each device that indicated they wanted a copy. Each WTRU that receives the copy may then store the data locally for later use.

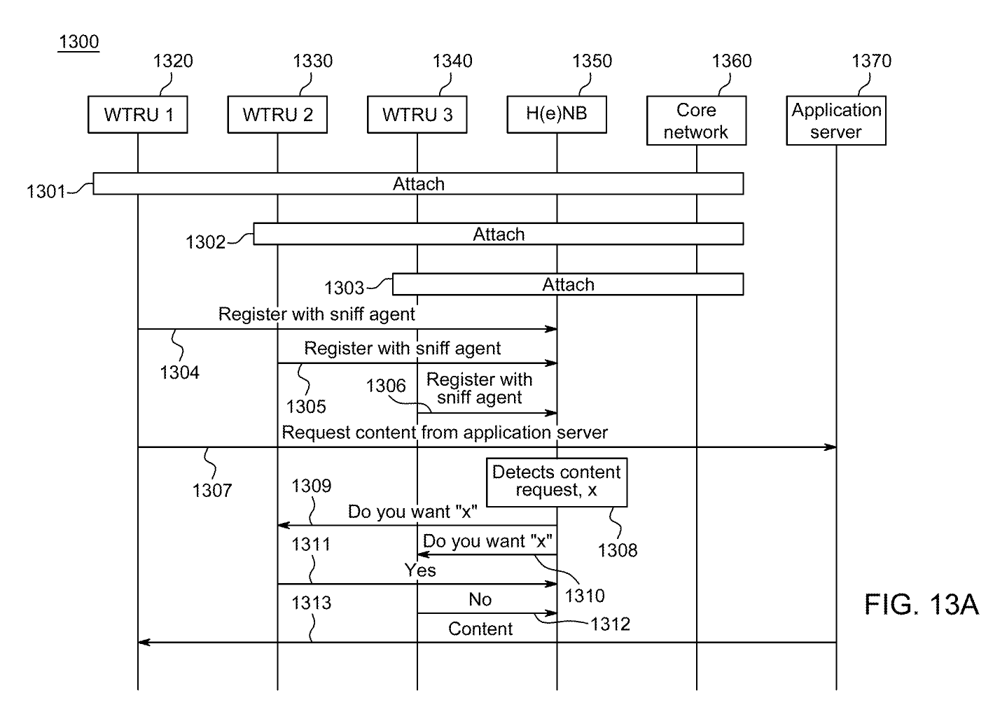

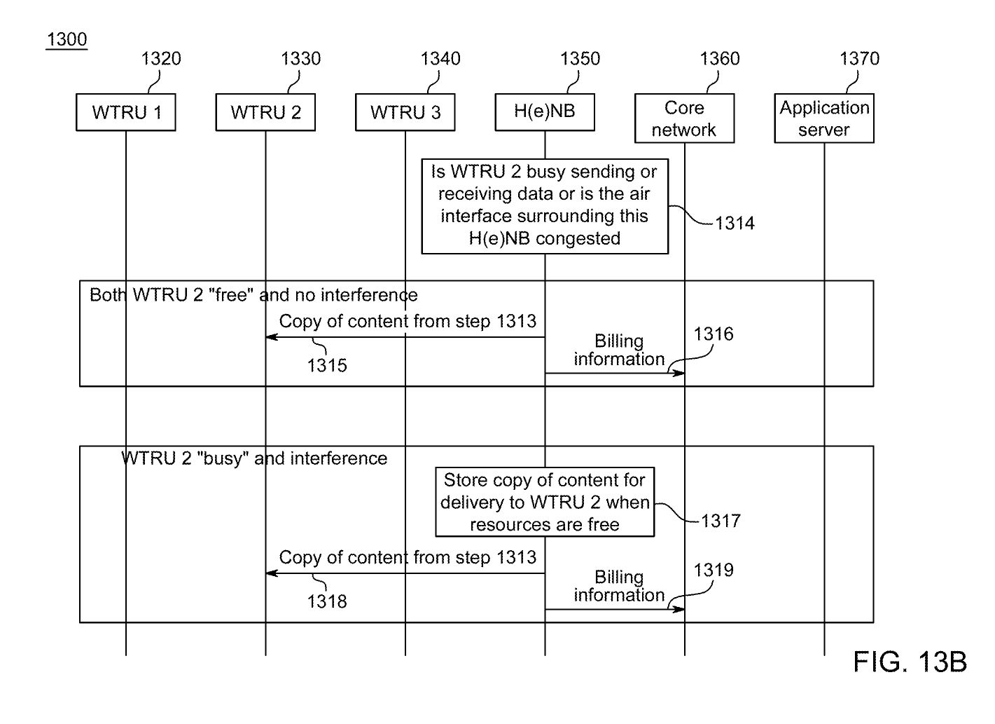

Each WTRU 1240, 1250, 1260 includes a Decision Agent 1270. The functions performed by the Decision Agent 1215 may be carried out in one or more processors or by software code run on one or more processors. However, not all WTRUs require the Decision Agent 1270 unless the WTRU participates in capture caching. As a result, legacy devices, roaming devices, etc. are able to function on the network, but will not have access to the caching. The Decision Agent 1270 is configured to use subscriber preferences for content to respond to requests from the Sniff Agent 1215 as to whether the each WTRU wants a copy of the data or not. The subscriber preferences may be locally entered by an end-user on the WTRU, may be stored somewhere in the core network, or may be deduced by the Decision Agent 1270 based on the history of the WTRU's activities. For example, if a user only downloads content of a specific genre, the Decision Agent 1270 may be configured to positively respond when queried about getting a copy of data in the same genre. An MSC for this behavior is shown in FIGS. 13A and 13B.

FIGS. 13A and 13B contain a diagram showing a message sequence chart (MSC) for capture caching using dedicated cellular networks. The network 1300 includes three end-user devices or WTRUs 1320, 1330, 1340, one H(e)NB 1350 and one application server 1370. The end-user devices 1320, 1330, 1340 and the H(e)NB 1350 are connected to a core network 1360. All three WTRUs are attached to the core network 1360 and have at least one dedicated channel (steps 1301, 1302, 1303). Each WTRU also registers with the Sniff Agent (not shown) in the H(e)NB 1350 so the H(e)NB is aware of the presence of the Decision Agent in each WTRU (steps 1304, 1305, 1306).

In step 1307, the WTRU1 1320 requests content from an application server 1370. This request passes through the H(e)NB 1350, where the request is detected by the Sniff Agent (step 1308). In step 1309, the Sniff Agent queries the Decision Agent in the WTRU2 1330 (step 1310) and the WTRU3 1340 (step 1311). In this case, WTRU2 responds affirmatively (step 1312) while the WTRU3 demurs (step 1313). The Sniff Agent remembers this. Then, the application server 1370 begins pushing content to WTRU1 1320 (step 1313) and the Sniff Agent detects this stream and allows the content to pass through to WTRU1 1320. The Sniff Agent will, however, also make a copy for delivery to the WTRU2 1330.

Prior to forwarding the content to WTRU2 1330, the Sniff Agent determines if WTRU2 1330 is currently sending or receiving data (step 1314). The Sniff Agent looks at the traffic passing through the H(e)NB 1350 to make this determination. The Sniff Agent also queries the H(e)NB 1350 as to the state of the air interface, whether or not the air interface is congested (step 1314). If WTRU2 1330 is not free and the air interface is “clear” the Sniff Agent delivers the content to WTRU2 1330 (step 1315). The H(e)NB 1350 then sends billing information to the core network 1360 (step 1316). If either WTRU2 1330 is already sending or receiving data or the air interface for the H(e)NB 1350 is congested, then the Sniff Agent stores the data locally and monitors both the state of the air interface and the traffic being sent or received by WTRU2 1330 (step 1317). Once WTRU2 1330 is not “busy” and the air interface is “clear” the Sniff Agent delivers the content to WTRU2 1330 (step 1318). Once received by WTRU2 1330, the content is stored in local cache for later use. The H(e)NB 1350 may then sends billing information to the core network 1360 (step 1319).

As to the protocol used to communicate between the WTRUs and H(e)NB for this purpose, there are several possibilities. For example, Open Mobile Alliance Device Management (OMA-DM) or Simple Object Access Protocol (SOAP) are protocols that may be used. Proprietary protocols could be used as well, perhaps using a client server model where the WTRU is the client device and the H(e)NB is the sever.

In the example described in FIGS. 13A and 13B, each end-user device registers with the Sniff Agent and is then queried as to whether or not the specific content that is passing Sniff Agent should be forwarded to each end-user device. Furthermore, the example also allows for the end-user device to automatically respond based on a user profile which may be populated in several ways.

An alternative to the registration and query paradigm may also be used. For example, if an end-user device requests a certain type of content, the Sniff Agent may query the Decision Agent in that end-user device as to whether or not it wishes to become a member of the group that participates in capture caching. Another alternative is for the Sniff Agent to interact with the Decision Agent as described in this paragraph in response to the end-user device requesting any type of content.

Another alternative is for the Sniff Agent to query the Decision Agent on all devices attached to the small cell sans the registration process. Still another alternative is for the Sniff Agent to monitor the content requested by a particular end-user device and decide to register the end-user device to the group participating in capture caching without the registration process. The intent of the above alternatives is to reduce the signaling associated with facilitating the inclusion of an end-user device in the group participating in capture caching.

The following embodiment involves caching and wired backhaul-offload via digital TV. Digital TV content is cached at the small cell network gateway (SCN GW) that sits at the edge of the small cell network. The SCN GW uses a digital TV antenna, or a DSM radio, to capture specific content and store it within the cache of the SCN GW. The SCN GW may decide which content to cache based on the users attached to the small cell network, preferences established by the small cell network or by a central entity coordinating which content is to be cached and where the content is to be cached. The intent of this embodiment is to highlight the caching of over-the-air (OTA) “free” content at the SCN GW for subsequent retrieval by end-user devices of the small cell network (SCN) and the charging mechanism to compensate content providers for the storage and use of this OTA “free” content.

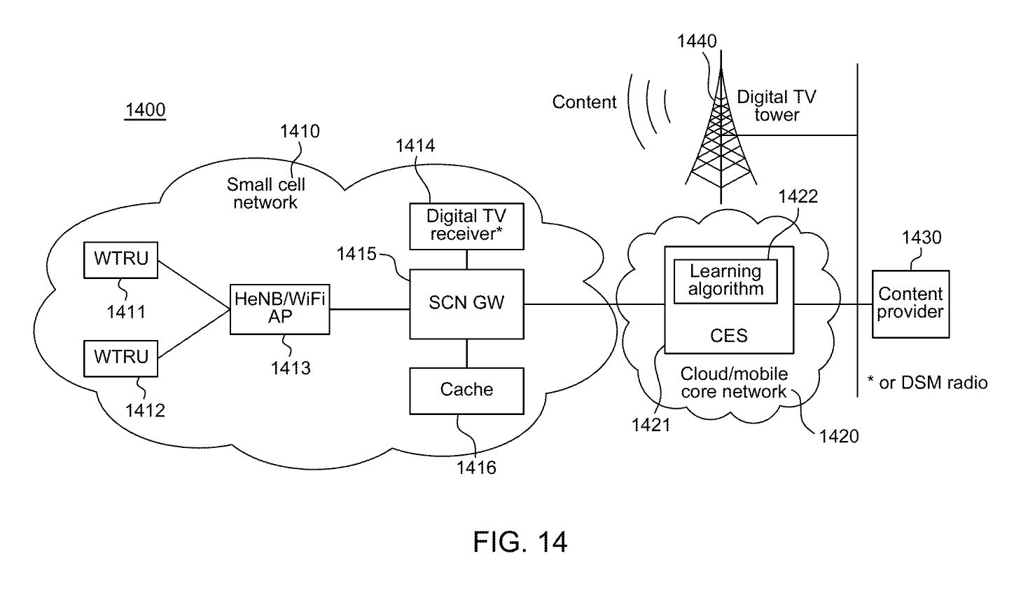

FIG. 14 shows an example of a digital TV caching topology. The digital TV caching topology 1400 contains a small cell network (SCN) 1410, a cloud/mobile core network 1420, a content provider 1430, and a digital TV tower 1440.

The SCN 1410 includes one or more WTRUs 1411, 1412, an AP 1413, and a SCN GW 1415. The SCN GW 1415 has a storage cache 1416 and a digital TV receiver 1414. The AP 1413 is either a Wi-Fi Access Point (AP) or Home (e)Node B (H(e)NB) and provides an air interface to end-user devices. While only one is shown, there could be several APs. As shown, the WTRUs 1411, 1412 are connected to the network through the AP 1413. It should be understood that while only one SCN 1410 is shown, there will be many SCNs, each with their own SCN GW, cache, digital TV antenna, APs and end-user devices.

The cloud/mobile core network 1420 includes a content enablement server (CES) 1421 that helps the SCN GW 1415 manage the local cache 1416 and interface to the content provider 1430. The CES 1421 has a learning algorithm 1422 which it uses to help deduce which content should be placed at the various caches across the various SCNs.

The content provider 1430 broadcast content OTA using digital TV towers 1440. Examples of content providers include ABC, CBS or NBC and their digital TV network transmitters.

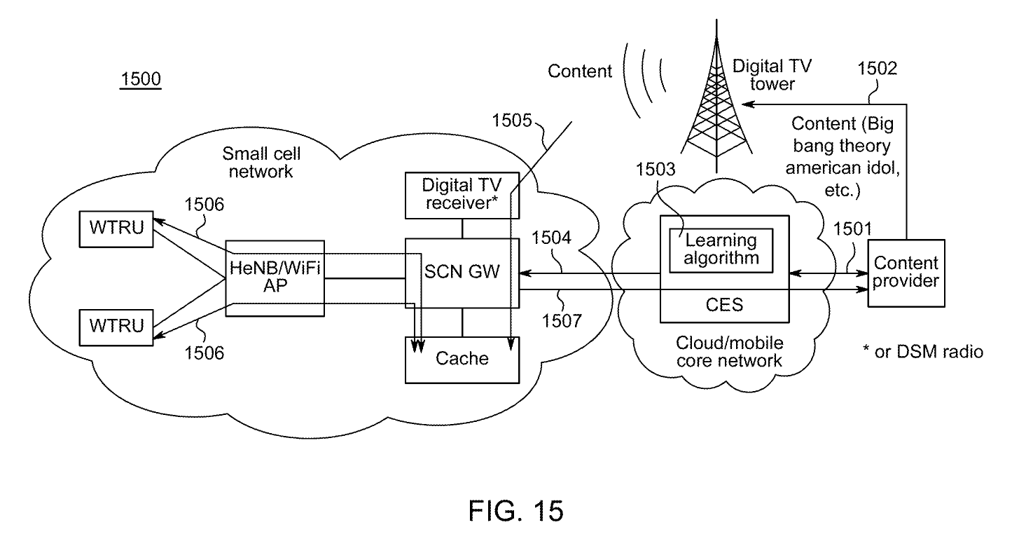

FIG. 15 shows a method for providing content caching in a digital TV caching topology. The method is used to disseminate the content, coordinate the caching of the OTA content, deliver the cached OTA content, and inform the content provider as to which content has been cached and subsequently delivered. The method is shown using the digital TV caching topology 1500 described in FIG. 14.

In step 1501, the SCN GW owner/Cloud operator/mobile core network operator has a business relationship with the content provider.

In step 1502, the content provider broadcasts content over their DTV channel. For example, using digital TV channel 37 in a certain city as per their FCC license.

In step 1503, the learning algorithm in the CES decides that the content might be requested by users/subscribers of the network.

In step 1504, the learning algorithm informs the various SCN GWs to cache the content broadcast over channel 37.

In step 1505, the digital TV receiver at the SCN GW is then tuned to channel 37 and receives the broadcast signal (which contains the content to be cached). The broadcast signal contains the content to be cached and the SCN GW converts the content into a storable form and the stores the content in a local cache.

In step 1506, the SCN GW advertises that this particular content is available, WTRUs within the small cell network request this stored content from the SCN GW cache, and the SCN GW then delivers this content using the AP to which the end-user device is attached.

In step 1507, the SCN GW informs the Content Provider about the use of the content for billing purposes. The Content Provider may then either bill the end-user device directly or thru the SCN GW owner. The Content Provider may also bill the SCN GW owner directly.

An average high definition 30 minute TV program requires between 150 and 400 MB of storage. Using this method, content is not sent over wired backhaul to the potentially thousands of small cells within the coverage area of the digital TV transmitter. Therefore, there is massive savings on the traditional, wired backhaul. Since the broadcasters are already broadcasting this information over digital TV, there is nothing extra for them to do, except be able to handle any signaling related to billing. However, this signaling should be orders-of-magnitude smaller than the size of the content itself. This enables a local DTV concept for mobile devices, allows a new revenue stream for broadcasters (without them having to do much at all), and provides a cogent use case for the small cell cache.

The following embodiment involves pre-fetch caching to alleviate a wired backhaul. In this embodiment, the digital TV spectrum is used to offload the wired backhaul. The content provider and SCN GW work together to use the digital TV spectrum to deliver content from the content provider to the SCN GW, and subsequently to users connected to the small cell network.

When the end-user devices request content from a content provider, the first portion of the content will be delivered in the traditional manner, through the wired backhaul to the AP in the small cell network serving the WTRU. Once the content is at the AP, it will be broadcast over the air to the end-user device. After the delivery of the first portion of the content, the content provider will broadcast the remainder of the content towards the end-user device using a digital TV channel within the digital TV spectrum. The digital TV receiver within the SCN GW will be tuned to the channel used by the content provider and will receive the balance of the content intended for the end-user device. The SCN GW will store this content within the local cache that is part of the SCN GW. The SCN GW will then satisfy the remainder of the content request for the end-user device using the content cached by the SCN GW. Once the transfer is complete, the SCN GW will inform the content provider for billing purposes.

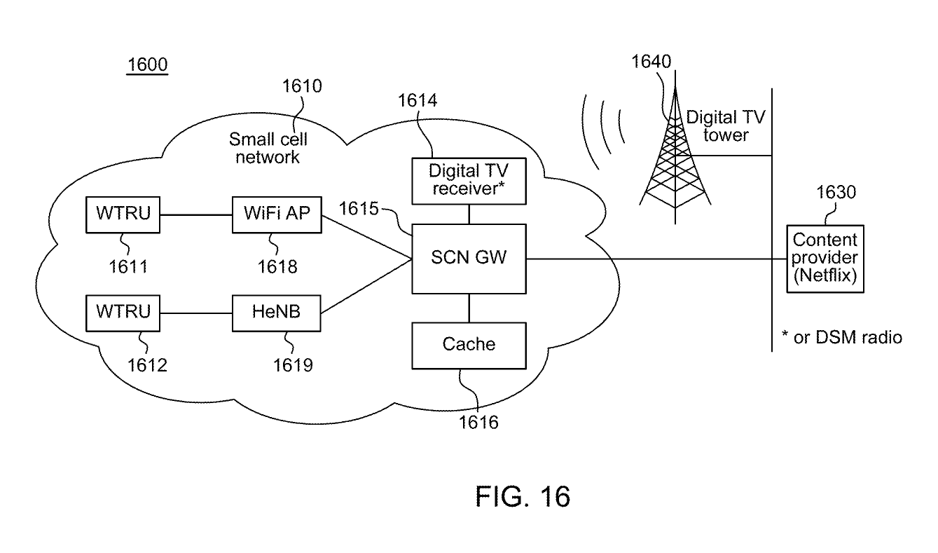

FIG. 16 shows an example of a pre-fetch caching topology. The pre-fetch caching topology 1600 contains a small cell network (SCN) 1610, a content provider 1630, and a digital TV tower 1640.

In the SCN 1610, there is an SCN GW 1615 that has a storage cache 1616 and a digital TV receiver 1614. There is either a Wi-Fi AP 1618 or a H(e)NB 1619 that provide an air interface to WTRUs 1611, 1612. While only one is shown, there could be several APs. As shown, there are one or more WTRUs 1611, 1612 connected to the network through the AP. It should be understood that while only one SCN is shown, there will be many SCNs, each with their own SCN GW, cache, digital TV antenna, APs and end-user devices.

There is also a content provider 1630, such as NetFlix, and a digital TV tower 1640 that allow for the broadcast of their content OTA.

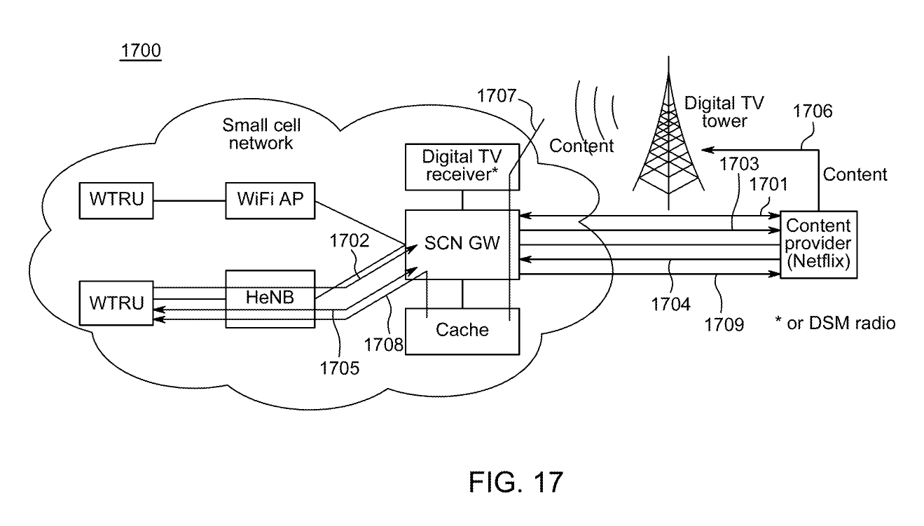

FIG. 17 shows a method for providing content in a pre-fetch caching topology. The method pre-fetches the content, delivers the pre-fetched cached OTA content, and informs the content provider as to which content has been cached and subsequently delivered. The method is shown using the pre-fetch caching topology 1600 described in FIG. 16.

In step 1701, the SCN GW owner/operator has a business relationship with the content provider.

In step 1702, the WTRU within the small cell network requests content from content provider, in this example NetFlix. This request is terminated by the SCN GW.

In step 1703, the SCN GW requests the content from the content provider.

In step 1704, the content delivery is started by the content provider towards the SCN GW via the wired backhaul. As part of this content delivery, the content provider informs the SCN GW that the balance of the file will be sent over a specific digital TV channel.

In step 1705, as the SCN GW receives the content, the SCN GW forwards this content to the WTRU via an AP (shown is HeNB, but it could be delivered via Wi-Fi AP). The SCN GW will also tune the digital TV receiver to the channel indicated in Step 1704.

In step 1706, the Content Provider forwards remainder of content to be delivered to a digital TV transmitter. As part of this forwarding, the content provider indicates which digital TV channel should be used for the transfer.

In step 1707, the digital TV transmitter will broadcast the remainder of the file as received from the content provider OTA.

In step 1708, the digital TV receiver at the SCN GW receives the content and stores the content in the cache attached to the SCN GW. The SCN GW then forwards the content to the end-user devices using the HeNB (or Wi-Fi AP).

In step 1709, the SCN GW informs the content provider about the use of the content for billing purposes. The content provider may either bill the end-user device directly or thru the SCN GW owner. The content provider may also bill the SCN GW owner directly.

The benefit of using this technique is described below. Typically, large files transfers, such as entire movies are broken into several smaller transfers. Using the disclosed embodiment, for large file transfers, only a small portion has to be sent over the wired backhaul. The remainder can be sent via DTV. Furthermore, if this is popular content, the cache now has a portion of the file, so for subsequent requests, most/some of the content is already placed at the local cache.

The following embodiment involves caching using digital TV frequencies to alleviate a wired backhaul. In this embodiment, there is a wired backhaul that exists between all the small cell networks and the content provider. It is presumed there are a large number of small cell networks and the passing of content from the content provider to the cache located in each small cell network will consume a large amount of the wired backhaul bandwidth. There could be up to one thousand small cell networks within a one square kilometer area. Using digital TV to broadcast this content over the area covered by a digital TV transmitter will reduce the amount of bandwidth consumed on the wired backhaul.

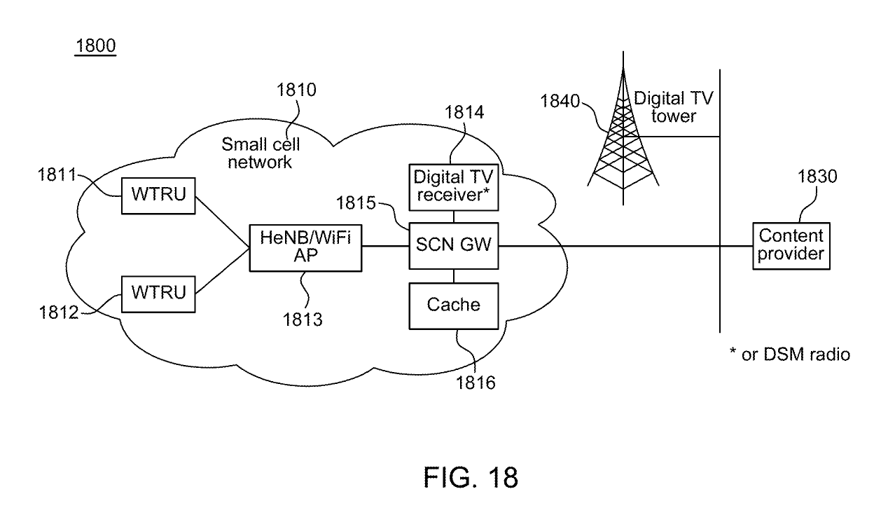

FIG. 18 shows an example of a caching to offload a wired backhaul topology. The caching to offload a wired backhaul topology 1800 contains a small cell network (SCN) 1800, a content provider 1830, and a digital TV tower 1840.

The SCN 1810 includes one or more WTRUs 1811, 1812, an AP 1813, and a SCN GW 1815. The SCN GW 1815 has a storage cache 1816 and a digital TV receiver 1814. The AP 1813 is either a Wi-Fi AP or a H(e)NB and provides an air interface to end-users. While only one is shown, there could be several APs. As shown there are also end-users devices connected to the network through the AR It should be understood that while only one SCN is shown, there will be many SCNs, each with their own SCN GW, cache, digital TV antenna, APs and end-user devices.

The content provider 1830, such as NetFlix, and the digital TV tower 1840 allows for the broadcast of their content OTA.

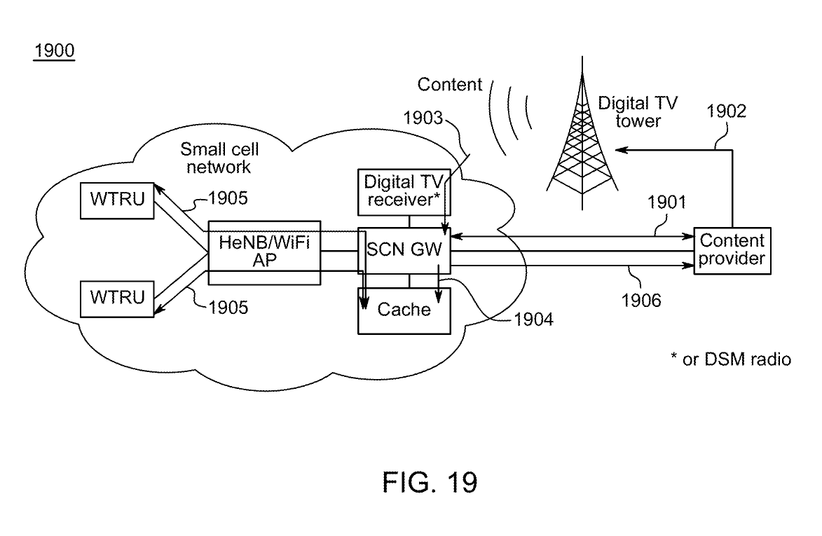

FIG. 19 shows a method for providing content in a caching to offload a wired backhaul topology. The method broadcasts content to be cached at many small cell networks simultaneously and subsequently delivers the content to an end-user. The method is shown using the caching to offload a wired backhaul topology described in FIG. 18.

In step 1901, the SCN GW owner/operator has a business relationship with the content provider. As such, the SCN GWs and DTV transmitter will know which channel to use to effectuate the transfer of content to the SCNs. Hence, both the transmitter and receiver will use the same channel to transmit and receive, respectively.

In step 1902, the content provider sends the content to be broadcast for caching to the DTV transmitter.

In step 1903, the DTV receiver at each small cell network receives the broadcast of the content to be cached. The content will be passed to the SCN GW.

In step 1904, the SCN GW stores this content in the cache that is attached to it.

In step 1905, at some later time, an end-user device may request the content. Upon receipt of the content request, the SCN GW retrieves the content from the cache and delivers the content to the end-user, using whichever air interface upon which the end-user is attached.

In step 1906, the SCN GW informs the content provider about the use of the content for billing purposes. The content provider may either bill the end-user directly or thru the SCN GW owner. The content provider may also bill the SCN GW owner directly.

Further, it should be understood that intelligence may be put into small cell networks to allow for only caching the content at particular small cell networks rather than all small cell networks as shown in the paragraphs above.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU) in a wireless network comprising:
capturing, at the WTRU, data packets that are directed to other devices in the wireless network and not directed to the WTRU, wherein the data packets are data packets of interest to the WTRU and the data packets of interest to the WTRU are determined based on a user profile associated with the WTRU;
storing, at the WTRU, the captured data packets in a cache, wherein the data packets are dropped if a number of errors associated with the data packets exceeds a threshold; and
reassembling, at the WTRU, the captured data packets on a condition that the WTRU requests content associated with the captured data packets.

2. The method of claim 1 further comprising:
determining, at the WTRU, that the captured data packets are missing a portion of data on a condition that the WTRU requests content associated with the captured data packets;
signaling a device in the wireless network to request the missing portion of data;
receiving the missing portion of data; and
repairing, at the WTRU, the missing portion of data using the captured data

3. (canceled)

4. The method of claim 1, wherein the data packets are marked to enable the WTRU to determine whether the data packets are of interest.

5. The method of claim 1 further comprising:
signaling a device in the wireless network to indicate data packets of interest to the WTRU.

6. The method of claim 1, wherein the captured data packets are directed to a broadcast group in the wireless network and the WTRU is not a member of the broadcast group.

7. A wireless transmit/receive unit (WTRU) comprising:
a transceiver and a sniffer configured to capture data packets that are directed to other devices in the wireless network and not directed to the WTRU, wherein the data packets are data packets of interest to the WTRU and the data packets of interest to the WTRU are determined based on a user profile associated with the WTRU;
a cache configured to store the captured data packets in a cache, wherein the data packets are dropped if a number of errors associated with the data packets exceeds a threshold; and
a reassembly unit configured to reassemble the captured data packets in the WTRU on a condition that the WTRU requests content associated with the captured data packets.

8. The WTRU of claim 7 further comprising:
a repair unit configured to repairing a missing portion of data using captured data packets, wherein the reassembly unit is further configured to determine that the captured data packets are missing a portion of data on a condition that the WTRU requests content associated with the captured data packets and the transceiver is further configured to signal a device in the wireless network to request the missing portion of data and to receive the missing portion of data.

9. (canceled)

10. The WTRU of claim 7, wherein the data packets are marked to enable the WTRU to determine whether the data packets are of interest.

11. The WTRU of claim 7, wherein the transceiver is further configured to signal a device in the wireless network to indicate data packets of interest to the WTRU.

12. The WTRU of claim 7, wherein the captured data packets are directed to a broadcast group in the wireless network and the WTRU is not a member of the broadcast group.

13. (canceled)

14. (canceled)
